(19) United States
(12) Patent Application Publication
(10) Pub. No.: US 2014/0325502 A1
(43) Pub. Date: Oct. 30, 2014

(54) PACKAGING, DISTRIBUTION AND DE-PACKAGING OF DEVICE-INDEPENDENT SOFTWARE APPLICATIONS

(71) Applicants: GIANNIS ZARIFIS, ATHENS (GR); COSTIS PAPADIMITRAKOPOULOS, LONDON (GB)

(72) Inventors: GIANNIS ZARIFIS, ATHENS (GR); COSTIS PAPADIMITRAKOPOULOS, LONDON (GB)

(21) Appl. No.: 13/932,913

(22) Filed: Jul. 1, 2013

Related U.S. Application Data
(60) Provisional application No. 61/665,916, filed on Jun. 29, 2012.

(51) Int. Cl. G06F 9/445

(52) U.S. Cl. CPC G06F 8/61
USPC 717/177

(57) ABSTRACT

The present invention is directed to techniques for servicing application software. Such techniques include the packaging of software application descriptions and related resources, and their distribution to target devices, like client devices. De-packaging the software packets by client devices is further described. A hierarchical approach to the packaging, distributing and de-packaging device-independent software applications is employed. The approach is based on having XML-based instructions configured to describe applications, where the application descriptions are agnostic of the client specific hardware and software capabilities of the client device on which the application description is to run. The packaged software application is configured to include the XML-based application description as well as relevant set of resources and attributes which will be required by the client device on receipt.

### RELATED APPLICATIONS

This application claims the benefit of U.S. Provisional Application No. 61/665,916, filed on Jun. 29, 2012, commonly owned and assigned to the same assignee hereof.

### BACKGROUND

1. Field

The present invention relates to the development of a method and system for servicing device-independent software.

2. Background

Software packages and applications have grown considerably in size and complexity. Typical software applications comprise hundreds or even thousands of files and folders, which are hard to track and manage. This is cumbersome when installing new software as very specific file structures and folders need to be replicated in the computing system or device where installation is required.

This process is further complicated since numerous security updates and fixes are introduced and newer versions are released periodically. They require an efficient mechanism to handle this vast amount of files and other resources that need to be copied or replaced so as to keep track of changes and ensure applications continue to run.

Another level of complexity is introduced by the dependencies of applications to common files (e.g. DLLs), other applications, operating systems and resources. A typical application may have several hundreds or thousands of dependencies, while a second application may depend on the said application.

It becomes apparent that servicing software applications under all these restrictions is a very complex task that requires an efficient and automated method to handle it. This is achieved by packaging software and resources into a structure that contains additional detailed information on dependencies, versions, file structures, etc. This information is usually implemented in the form of header files containing all the data and instructions (e.g. in the form of scripts) that are needed for a computing system or device to automatically perform the installation, fix and update an application.

Nevertheless, the whole process is still very computationally intensive and when networks are involved in the transmission of the packaged software, high bandwidths are required.

Another level of complexity is added as hundreds of computing devices with diverse characteristics and running various operating systems need to be supported. As a result, a plurality of versions of the same applications and packaged software need to be produced, serviced and distributed.

There is a clear need for an efficient mechanism that will simplify application servicing.

### BRIEF DESCRIPTION OF THE DRAWINGS

FIG. 1 illustrates an exemplary system for developing, packaging, distribution and de-packaging a software application description.

FIG. 2 presents the general structure of a software package.

FIG. 3 illustrates a hierarchical scheme for a software application.

FIG. 4 graphically shows the distribution of a packaged software in accordance with an exemplary embodiment.

### SUMMARY

Improved techniques for packaging an application description for transmission and de-packaging same by a client device running embedded software are described.

The application description is created by selecting a set of XML-based instructions, and is agnostic of the client specific hardware and software capabilities of the client device on which the application description is to run. The software package is created by selecting a set of resources and attributes configured to be included with the application description for transmission to a client device. Upon reception, the client device uses a method to de-package the software package, and the client device generates an application from the application description, the set of resources and attributes, and from locally embedded client specific hardware and software capabilities associated with the client device.

The resources and attributes included in the software package may include data and metadata that describe among others directories, dependencies, versions, storage requirements for installation, lists of target computing devices, and scripts.

In one embodiment of the invention, the packaged software comprises device-independent descriptions of software applications using an XML-based language. No executable files are contained in the package objects.

This application description is based on a hierarchical layered scheme where XML-based application descriptions are isolated from source and executable code. The isolation is achieved by using client embedded software that interprets the application description, builds the application, and invokes device and operating-system-specific routines. The proposed method simplifies servicing of software and supports the description of applications once, instead of creating and updating a multitude of versions for the plurality of available computing devices and operating systems. The proposed method isolates the application (XML-based) description from dependencies on other software components.

An exemplary client-server system is presented for software distribution to target computing devices. The system supports a plurality of distribution modes for application debugging, testing, use, and versioning.

Application software distribution is followed by de-packaging whereby the application is installed at the target computing device, and activated according to dependencies, user and devices privileges, and licenses.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

The present invention is directed to techniques for servicing application software. In particular, it describes techniques for packaging software application descriptions and related resources, distributing them to target devices, like client devices, and de-packaging the software packets on the client devices.

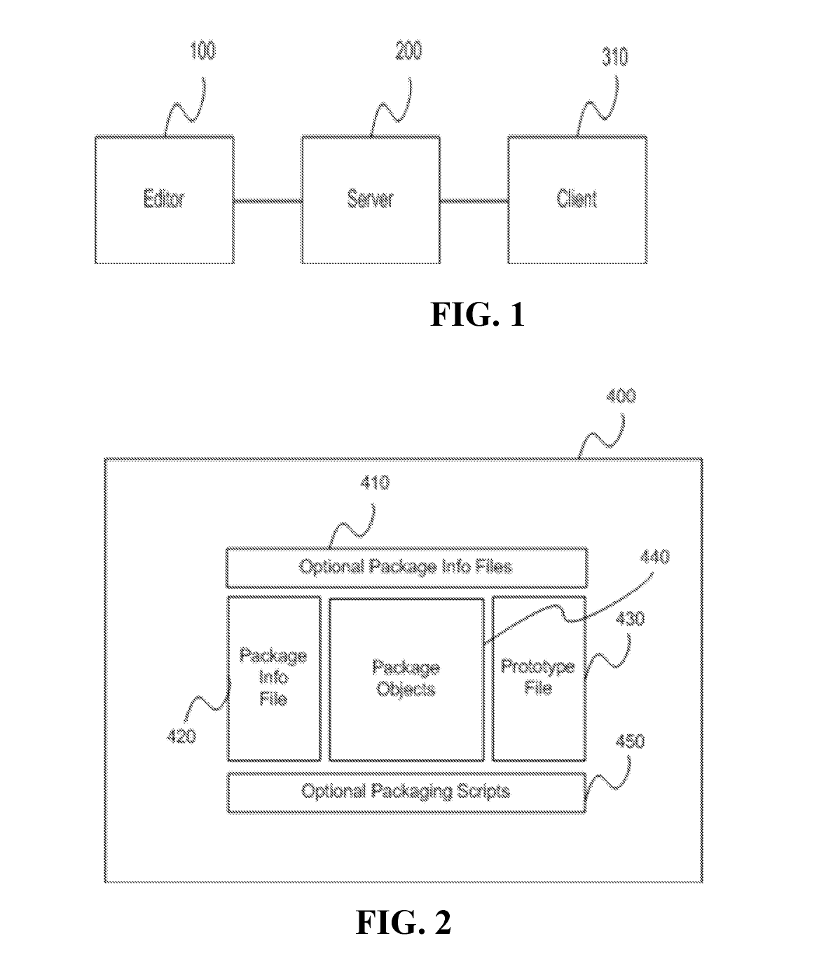

FIG. 1 illustrates an exemplary system for developing, packaging, distribution and de-packaging a software application description. A client-server architecture is presented where a server 200 is connected through a network to a client computing device 310. The server 200 is used to store and distribute software applications that are created and packaged by an editor 100.

The software applications are described using XML-based instructions that are agnostic of the client specific hardware and software capabilities of the client device on which the application description is to run.

The software package is constructed by selecting a set of resources and attributes configured to be included with the application description for transmission to a client device. When received and de-packaged by the client device, the client embedded software interprets the application description and generates an application from the application description, the set of resources and attributes, and from locally embedded client specific hardware and software capabilities associated with the client device.

In an exemplary embodiment of the invention, the packaged software is distributed to the client 310 where de-packaging is performed.

FIG. 2 presents the general structure of a software package. Software package 400 is made up of a plurality of components that are necessary or optional. Necessary components include the package objects 440, the package information file 420, and the prototype file 430. Optional components include optional package information files 410, and optional packaging scripts 450.

The package objects 440 are the software components that are packaged and may form part of a certain application. They may comprise, but are not limited to, XML-based application description files, executable or source code files, data files, directories, named pipes, and links. In one embodiment, the package objects may contain one of the following; XML-based application description, executable code, source code. In other embodiments the package objects may contain all or a combination of the above items.

The package information file 420 may contain parameter values (e.g. package abbreviations), full package name, package version, package description language version, client software version, application developers, and compatible hardware configurations.

The prototype file 430 comprises a list of the package components. It may contain, but is not limited to, file location, attributes, and type.

Optional package information file 410 may contain, but is not limited to, previous compatible versions of the package, software dependencies associated with the package, storage space requirements for the target computing device where the software will be de-packaged and installed, and copyright messages that are presented to the user during installation of the package, domains or computing devices where the application may be installed, default application parameters, dependencies on other applications, and sharing of application elements among developers.

Optional packaging scripts 450 are scripts that perform certain actions, e.g. request user input during installation.

In one embodiment of the invention, the package objects 440 are device-independent descriptions of software applications. No executable files are contained in the package objects. Instead, a generic description of the application is used.

In another embodiment, the application is described using an eXtensible Mark-up Language (XML). This description adds a level of abstraction between the application description and the dependent software, e.g. operating system-specific software.

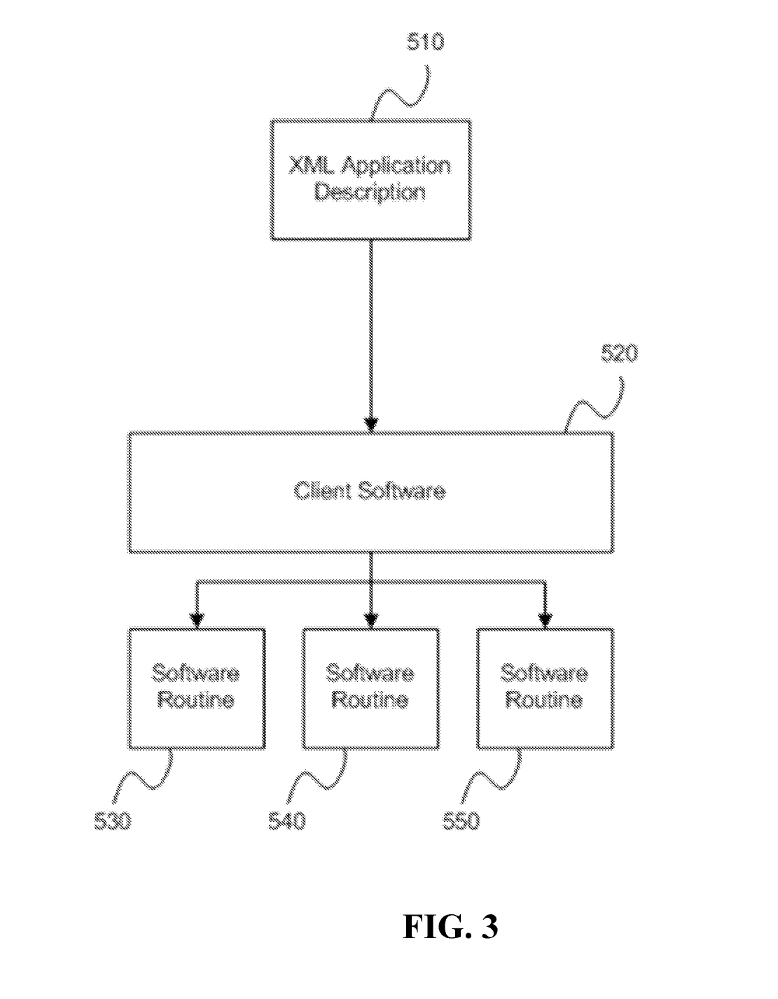

FIG. 3 illustrates a hierarchical scheme for a software application. At the top level, the XML description 510 describes the application in terms of main components. For example an e-mail application, may be described in terms of a “send to”, “copy”, “subject” etc. components in XML without any source or executable code.

The isolation of the above description from the dependent software is achieved by a second layer, a client embedded software 520. The client software 520 is unrelated to the above application. It can read and interpret the above XML description 510 and call the appropriate basic software routines 530-550 that service the entries of the XML description 510. The software routines 530-550 are device and operating-system-specific and are shared by any application using the said XML language. The client software 520 and the software routines 530-530 exist in several versions, one for each supported device and operating system.

This architecture for software development, allows the developer to describe an application once and run it on any type of computing device running any operating system.

The client software 520 and the invoked software routines 530-550 can be used for any application described with the proposed XML-based language. They need to be replaced by new versions only when the XML-based language definition is changed or updated, or when the operating system is updated.

The advantage offered by this approach is a simplification of the application development process and software servicing. A user of ordinary skill in programming can easily understand that the servicing of the client software 520 and the software routines 530-550 is a rare event. It needs to be done when the operating system of the target computing device changes, or when a new version of the XML-based language is made available. On the contrary, application development and servicing is an intensive process that may be repeated several times when the application is developed, updated, etc.

Software applications may be parameterized to allow user access to a subset or the full set of functionalities. The functionalities offered to the user may be modified several times during the lifecycle of an application. This approach may result in several versions of the application being developed for each user.

The proposed method isolates application (XML) description 510 from dependencies on other software components. The XML description depends only on the client software 520. A different version of the client software 520 and software routines 530-550 is developed for each operating system.

During software packaging the XML-based language version and the client software version may be added to the package information file 420, described in FIG. 2, when new versions are available and have not previously been installed to the client device.

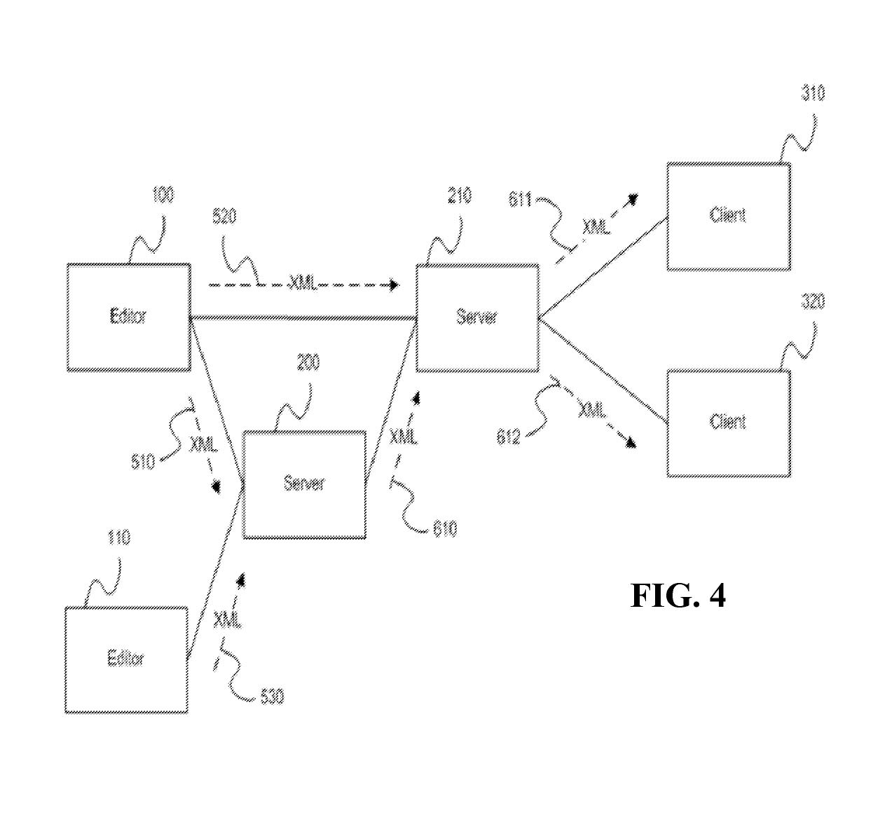

In an exemplary embodiment, the distribution of the packaged software is illustrated in FIG. 4. Editor 100 is used to edit the application description and package it with the method described in FIG. 2 and FIG. 3. The packaged application description 510 is sent to the server 200 where it is stored. The server 200 stores a plurality of versions of the same application, together with other applications, and versions of the client software.

In an exemplary embodiment, four versions of software distribution are included; Debug distribution, Export to server, Export to developer, and Export and Upload.

The Debug distribution is used to distribute packaged software to software developers. The packaged application description 510 may be sent by server 200 to a server 210 along with parameters initialized to values that allow certain developers to access it and perform operations comprising among others, setting of application variables.

The Export to server distribution is used to distribute packaged software to testers for testing the applications prior to installation and release to users. In this distribution version alerts (not shown in FIG. 4) are sent to testers which are defined in the optional package information file 410.

The Export to developer distribution is identical to the Debug distribution but the packaged software 520 is sent by the editor 100 directly to the server 210. Server 210 sends packaged software 611-612 to the client devices 310-320, bypassing server 200.

The Export and Upload distribution is used to package application descriptions 510 or client software stored in server 200 and upload the new package 610 to server 210. In this embodiment, the server 210 is a versioning server. It is a central archive of applications and client software.

In another embodiment, the Versioning Server 210 may be an Application e-Store.

In another embodiment the versioning server 210 and the server 200 are the same server.

In another embodiment editor 110 may upload packaged software 530 to the server 200. Server 210 may get software from server 200 that has been created by a plurality of editors. The server 200 may be an Application e-Store.

Server 200 logs all software that is saved by editors 100-110 and uploaded to server 210. The logged information may include, but is not limited to version numbers, developer name, time and date.

The proposed invention comprises a de-packaging step at a client computing device. De-packaging consists of installation and activation steps.

Installation comprises a subset or all of the following; creates directory structure, installs application descriptions, installs client executable software if the version specified in the package information file 420 is not present in the target client device, installs resources needed by the installed client software, and makes installed software entries available to the Activation step.

Activation comprises some or all of the following steps; maintains and manages resolution policies for client software, resolves dependencies, sets application settings, resolves user and device licenses, authenticates users, constructs the environment in which the application runs, and initiates the running of the software.

Various embodiments of the invention are described above in the Detailed Description. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s).

The foregoing description of a preferred embodiment and best mode of the invention known to the applicant at this time of filing the application has been presented and is intended for the purposes of illustration and description. It is not intended to be exhaustive or limit the invention to the precise form disclosed and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated. Therefore, it is intended that the invention not be limited to the particular embodiments disclosed for carrying out this invention, but that the invention will include all embodiments falling within the scope of the appended claims.

In one or more exemplary embodiments, the functions described may be implemented in hardware, software, firmware, or any combination thereof. If implemented in software, the functions may be stored on or transmitted over as one or more instructions or code on a computer readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A method of packaging an application description for transmission and de-packaging by a client device, the client device being of the type having client embedded software for creating an application from the application description and from client specific hardware and software capabilities, comprising:
selecting a set of XML-based instructions configured to be interpreted by the client device;
creating the application description using the selected set of XML-based instructions, where the application description is agnostic of the client specific hardware and software capabilities of the client device on which the application description is to run; and
selecting a set of resources and attributes configured to be included in a software package with the application description for transmission to a client device, wherein the software package when received and de-packaged by the client device generates an application from the application description, the set of resources and attributes, and from locally embedded client specific hardware and software capabilities associated with the client device.

2. The method of claim 1, where the contents of the said package are organized in files.

3. The method of claim 1, where the resources and attributes of the said package comprise at least one of package name, version, language, application developer, compatible hardware configuration, previous compatible versions of the package, client software dependencies, copyright messages, permissible domains or computing devices where the application may be installed, application parameters, dependencies on other applications, sharing of application elements among developers, scripts.

4. The method of claim 3, where the said resources and attributes are configured to condition and regulate user access to at least a subset of the said application functionalities.

5. The method of claim 1, where the resources and attributes of the said package are configured to condition the creation of the said application by the client device in a version suitable for one of:
debugging;
testing, where the said package is sent directly to at least one user identified as tester;
testing, where the said package is first sent to a first server prior to transmission to at least one user identified as tester; and
versioning, where the software package is archived at a second server.

6. The method of claim 5, where the second server is one of:
a versioning server;
an application e-store; and
the second server and the first server are the same.

7. The method of claim 5, where the first server logs information, the logged information comprising at least one of:
version number;
developer name;
time; and
date.

8. A device configured for packaging an application description for transmission and de-packaging by a client device, where the client device is of the type having client embedded software for creating an application from the application description and from client specific hardware and software capabilities, comprising:
means for selecting a set of XML-based instructions configured to be interpreted by the client device;
means for creating the application description using the selected set of XML-based instructions, where the application description is agnostic of the client specific hardware and software capabilities of the client device on which the application description is to run; and
means for selecting a set of resources and attributes configured to be included in a software package with the application description for transmission to a client device, wherein the software package when received and de-packaged by the client device generates an application from the application description, the set of resources and attributes, and from locally embedded client specific hardware and software capabilities associated with the client device.

9. The device of claim 8, where the means for selecting the set of resources and attributes configured to be included in the software package organize the contents of the said package in files.

10. The device of claim 8, where the means for selecting the set of resources and attributes configured to be included in the software package comprise means for selecting at least one of package name, version, language, application developer, compatible hardware configuration, previous compatible versions of the package, client software dependencies, copyright messages, permissible domains or computing devices where the application may be installed, application parameters, dependencies on other applications, sharing of application elements among developers, scripts.

11. The device of claim 10, where the means for selecting the set of resources and attributes configured to be included in the software package, comprise means for conditioning and regulating user access to at least a subset of the said application functionalities.

12. The device of claim 8, where the means for selecting the set of resources and attributes configured to be included in the software package comprise means for conditioning the creation of the said application by the client device in a version suitable for one of:
debugging;
testing, where the said package is sent directly to at least one user identified as tester;
testing, where the said package is first sent to a first server prior to transmission to at least one user identified as tester; and
versioning, where the software package is archived at a second server.

13. The device of claim 12, where the second server is one of:
a versioning server;
an application e-store; and
the second server and the first server are the same.

14. The device of claim 12, where the first server has means for logging information, and the logged information comprising at least one of:
version numbers;
developer name;
time; and
date.

15. A non-transitory computer program product having computer program instructions which when executed on a computing device cause the computing device to package an application description for transmission and de-packaging by a client device, where the client device is of the type having client embedded software for creating an application from the application description and from client specific hardware and software capabilities, the computer instructions including causing the computing device to:
select a set of XML-based instructions configured to be interpreted by the client device;
create the application description using the selected set of XML-based instructions, where the application description is agnostic of the client specific hardware and software capabilities of the client device on which the application description is to run; and
select a set of resources and attributes configured to be included in a software package with the application description for transmission to a client device, wherein the software package when received and de-packaged by the client device generates an application from the application description, the set of resources and attributes, and from locally embedded client specific hardware and software capabilities associated with the client device.

16. The non-transitory computer program product of claim 15, where the contents of the said package are organized in files.

17. The non-transitory computer program product of claim 15, where the resources and attributes of the said package comprise at least one of package name, version, language, application developer, compatible hardware configuration, previous compatible versions of the package, client software dependencies, copyright messages, permissible domains or computing devices where the application may be installed, application parameters, dependencies on other applications, sharing of application elements among developers, scripts.

18. The non-transitory computer program product of claim 17, where the said resources and attributes are configured to condition and regulate user access to at least a subset of the said application functionalities.

19. The non-transitory computer program product of claim 15, where the resources and attributes of the said package are configured to condition the creation of the said application by the client device in a version suitable for one of:
debugging;
testing, where the said package is sent directly to at least one user identified as tester;
testing, where the said package is first sent to a first server prior to transmission to at least one user identified as tester; and
versioning, where the software package is archived at a second server.

20. The non-transitory computer program product of claim 19, where the second server is one of:
a versioning server;
an application e-store; and
the second server and the first server are the same.

21-27. (canceled)
